(19) United States
(12) Patent Application Publication
(10) Pub. No.: US 2016/0076717 A1
(43) Pub. Date: Mar. 17, 2016

(54) Selectable color scheme light string assembly

(71) Applicants: DUSTIN MAGNER, LUTZ, FL (US); REBECCA MAGNER, LUTZ, FL (US)

(72) Inventors: DUSTIN MAGNER, LUTZ, FL (US); REBECCA MAGNER, LUTZ, FL (US)

(21) Appl. No.: 14/487,695

(22) Filed: Sep. 16, 2014

(51) Int. Cl. F21S 10/02; F21V 3/02; F21V 23/02; F21S 4/00; F21V 23/00

(52) U.S. Cl. CPC F21S 10/023; F21S 4/001; F21V 23/003; F21V 23/02; F21V 23/001; F21V 3/02; F21W 2121/00

(57) ABSTRACT

The light display assembly includes a plurality of bulbs each evenly spaced apart and distributed along a conductor. The plurality of bulbs comprises a pair of light emitters operationally coupled together. A control is operationally coupled to the plurality of bulbs. A plurality of actuators is coupled to the control. The plurality of actuators selects a color emitted by the plurality of bulbs.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of light string assemblies, more specifically, selectable color scheme light string assemblies.

### SUMMARY OF THE INVENTION

An embodiment of the disclosure meets the needs presented above by generally comprising a plurality of bulbs each evenly spaced apart and distributed along a conductor. The plurality of bulbs comprises a pair of light emitters operationally coupled together. A control is operationally coupled to the plurality of bulbs. A plurality of actuators is coupled to the control. The plurality of actuators selects a color emitted by the plurality of bulbs.

An object of the invention is to provide a device that is selectable color scheme light string assembly.

These together with additional objects, features and advantages of the selectable color scheme light string assembly will be readily apparent to those of ordinary skill in the art upon reading the following detailed description of presently preferred, but nonetheless illustrative, embodiments of the selectable color scheme light string assembly when taken in conjunction with the accompanying drawings.

In this respect, before explaining the current embodiments of the selectable color scheme light string assembly in detail, it is to be understood that the selectable color scheme light string assembly is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the selectable color scheme light string assembly.

It is therefore important that the claims be regarded as including such equivalent construction insofar as they do not depart from the spirit and scope of the selectable color scheme light string assembly. It is also to be understood that the phraseology and terminology employed herein are for purposes of description and should not be regarded as limiting.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a light display assembly according to an embodiment of the disclosure.

FIG. 2 is a front view of an embodiment of the disclosure.

FIG. 3 is an in-use view of an embodiment of the disclosure.

FIG. 4 is a schematic view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

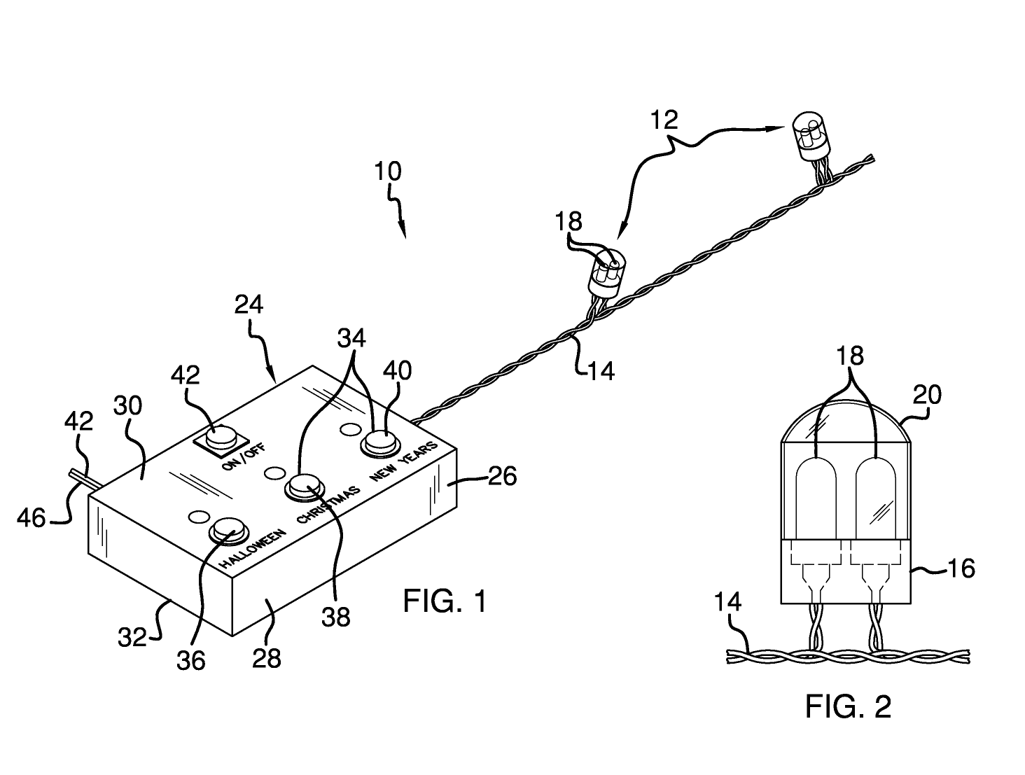

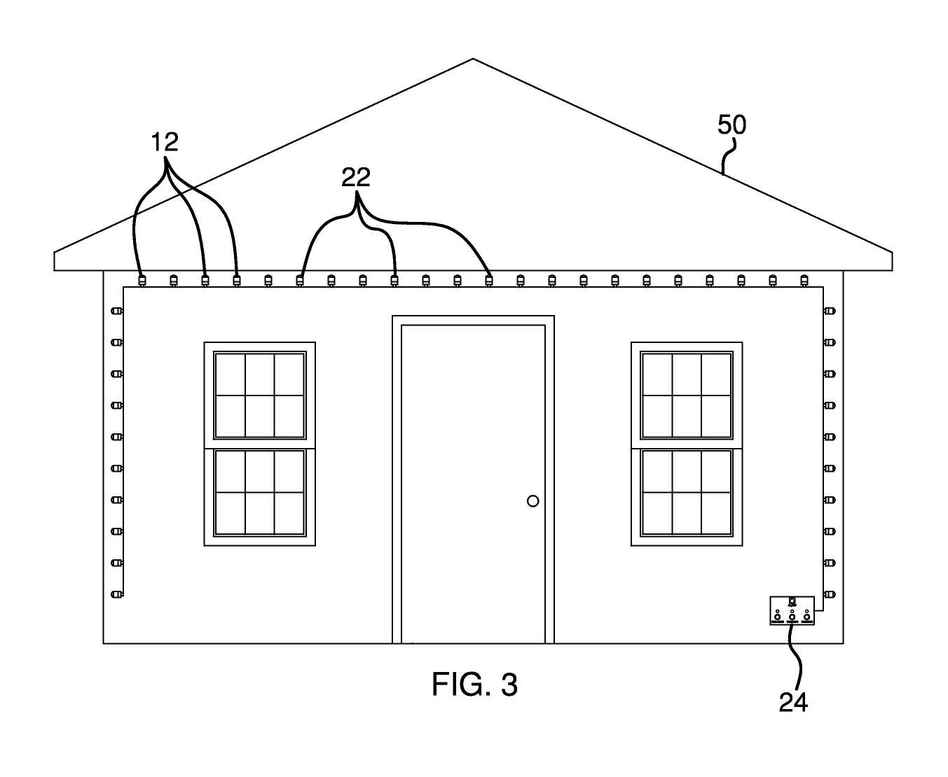

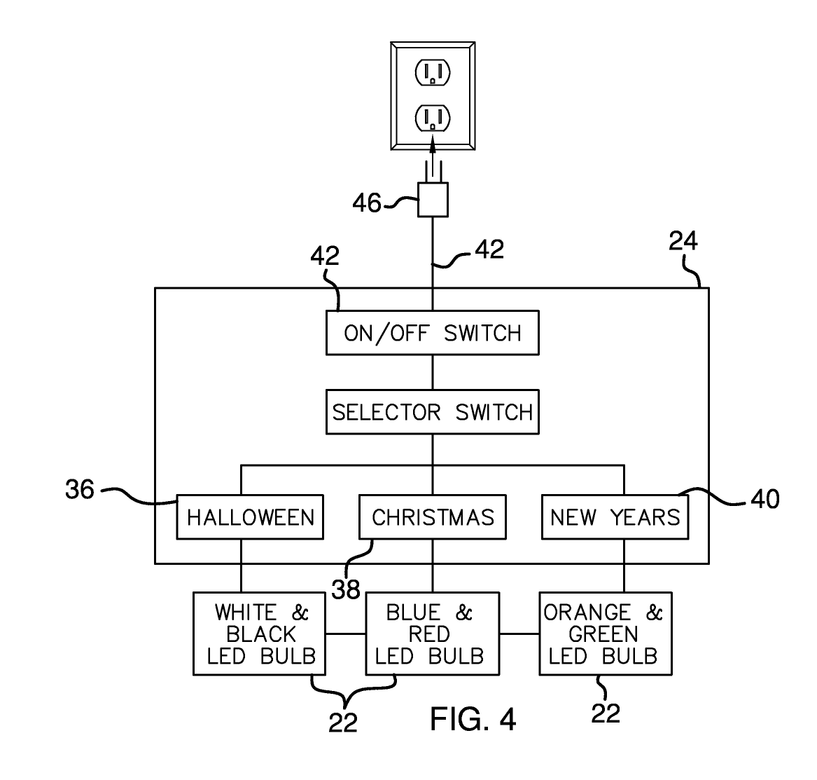

As best illustrated in FIGS. 1 through 4, the light display assembly 10 generally comprises a plurality of bulbs 12. The plurality of bulbs 12 is each evenly spaced apart and distributed along a conductor 14. The conductor 14 may be an electrical wire of any conventional design.

The plurality of bulbs 12 comprise a base 16 electrically coupled to the conductor 14. Additionally, the plurality of bulbs 12 comprises a pair of light emitters 18 electrically coupled together. The pair of light emitter 18 may each be an LED of any conventional design. Each of the pair of light emitters 18 in the plurality of bulbs 12 emits a different color of light.

The plurality of bulbs 12 further comprises a dome 20 coupled to the base 16. The dome 20 may be comprised of a translucent material. The pair of light emitters 18 each is electrically coupled to the base 16. The dome 20 covers each of the pair of light emitters 18.

The plurality of bulbs 12 comprise a plurality of groups of the bulbs 22. Each of the plurality of groups of the bulbs 22 emits a pair of colors of light. The pair of colors of light corresponds to various holidays. The various holidays may be Christmas, Halloween and New Year's Day.

The pair of colors corresponding to Christmas may be red and blue. Additionally, the pair of colors corresponding to Halloween may be white and black. The pair of colors corresponding to New Year's Day may be orange and green.

A control 24 is provided. The control 24 has an outer wall 26. Moreover, the outer wall 26 of the control 24 has an exterior side 28 extending between each of a top side 30 and a bottom side 32 of the outer wall 26 of the control 24.

A plurality of actuators 34 is coupled to the top side 30 of the outer wall 26 of the control 24. The plurality of actuators 34 is each electrically coupled to the conductor 14. Additionally, the plurality of actuators 34 comprise a Halloween one 36, a Christmas one 38, a New Year's one 40 and an On/Off one 42 of the plurality of actuators 34. Each of the Halloween 36, Christmas 38 and New Year's 40 actuators is actuated so the pair of light emitters 18 in an associated one of the plurality of groups of bulbs 22 emits the corresponding pair of colors of light.

A power supply 44 is coupled to the control 24. The power supply 44 is electrically coupled to the plurality of actuators 34. Additionally, the power supply 44 comprises a power cord 46 extending outwardly from an outer wall 26 of the control 24. The power cord 46 is electrically coupled to a power source 48. The power source 48 may be an electrical outlet of any conventional design.

In use, the conductor 14 is coupled to a building 50. The building 50 may be a house. A selected one of the Halloween 36, Christmas 38 or New Year's 40 actuators is actuated. The associated pair of colors is emitter by the plurality of bulbs 12. The assembly 10 permits a festive display for a variety of holidays without removing and replacing the conductor 14 on the building 50.

With respect to the above description, it is to be realized that the optimum dimensional relationship for the various components of the light display assembly 10, to include variations in size, materials, shape, form, function, and the manner of operation, assembly and use, are deemed readily apparent and obvious to one skilled in the art, and all equivalent relationships to those illustrated in the drawings and described in the specification are intended to be encompassed by the light display assembly 10.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A light display assembly configured to emit a selected one of a plurality of colors of light wherein the plurality of colors relates to various holidays, said assembly comprising:
a plurality of bulbs each evenly spaced apart and distributed along a conductor;
said plurality of bulbs comprising a pair of light emitters operationally coupled together; and
a control operationally coupled to said plurality of bulbs; and
a plurality of actuators coupled to said control, said plurality of actuators selecting a color emitted by said plurality of bulbs.

2. The assembly according to claim 1, wherein said plurality of bulbs comprising a base electrically coupled to said conductor.

3. The assembly according to claim 2, wherein said plurality of bulbs further comprising a dome coupled to said base.

4. The assembly according to claim 3, wherein said pair of light emitters each being electrically coupled to said base such that said dome covers each of said pair of light emitters.

5. The assembly according to claim 4, wherein said plurality of bulbs comprising a plurality of groups of said bulbs, each of said plurality of groups of said bulbs emitting a pair of colors of light corresponding to the various holidays.

6. The assembly according to claim 1, wherein said control having an outer wall.

7. The assembly according to claim 6, wherein said outer wall of said control having an exterior side extending between each of a top side and a bottom side of said outer wall of said control.

8. The assembly according to claim 7, wherein said plurality of actuators being coupled to said top side of said outer wall of said control.

9. The assembly according to claim 8, wherein said plurality of actuators each being electrically coupled to said conductor.

10. The assembly according to claim 1, wherein said plurality of actuators comprising a Halloween one, a Christmas one, a New Year's one and an On/Off one of said plurality of actuators.

11. The assembly according to claim 10, wherein each of said Halloween, Christmas and New Year's actuators being actuated such that a pair of light emitters in said plurality of bulbs emits a light having a color corresponding to an associated one of the various holidays.

12. The assembly according to claim 1, wherein a power supply coupled to said control.

13. The assembly according to claim 12, wherein said power supply being electrically coupled to said plurality of actuators.

14. The assembly according to claim 13, wherein said power supply comprising a power cord extending outwardly from an outer wall of said control.

15. The assembly according to claim 14, wherein said power cord being electrically coupled to a power source.

16. A light display assembly configured to emit a selected one of a plurality of colors of light wherein the plurality of colors relates to various holidays, said assembly comprising:
a plurality of bulbs each evenly spaced apart and distributed along a conductor, said plurality of bulbs comprising a base electrically coupled to said conductor;
said plurality of bulbs comprising a pair of light emitters operationally coupled together; and
a control operationally coupled to said plurality of bulbs; and
a plurality of actuators coupled to said control, said plurality of actuators selecting a color emitted by said plurality of bulbs.

17. The assembly according to claim 16, wherein said plurality of bulbs further comprising a dome coupled to said base; said pair of light emitters each being electrically coupled to said base such that said dome covers each of said pair of light emitters; said plurality of bulbs comprising a plurality of groups of said bulbs; each of said plurality of groups of said bulbs emitting a pair of colors of light corresponding to the various holidays.

18. The assembly according to claim 16, wherein said control having an outer wall; said outer wall of said control having an exterior side extending between each of a top side and a bottom side of said outer wall of said control; said plurality of actuators being coupled to said top side of said outer wall of said control; said plurality of actuators each being electrically coupled to said conductor.

19. The assembly according to claim 16, wherein said plurality of actuators comprising a Halloween one, a Christmas one, a New Year's one and an On/Off one of said plurality of actuators; each of said Halloween, Christmas and New Year's actuators being actuated such that a pair of light emitters in said plurality of bulbs emits a light having a color corresponding to an associated one of the various holidays.

20. The assembly according to claim 16, wherein a power supply coupled to said control; said power supply being electrically coupled to said plurality of actuators; said power supply comprising a power cord extending outwardly from an outer wall of said control; said power cord being electrically coupled to a power source.
